(19) United States
(12) Patent Application Publication
(10) Pub. No.: US 2010/0176042 A1
(43) Pub. Date: Jul. 15, 2010

(54) Wastewater Concentrator

(76) Inventors: Bernard F. Duesel, JR., Goshen, NY (US); Michael J. Rutsch, Tulsa, OK (US)

Correspondence Address: MARSHALL, GERSTEIN & BORUN LLP, 233 SOUTH WACKER DRIVE, 6300 WILLIS TOWER, CHICAGO, IL, 60606-6357, US

(21) Appl. No.: 12/530,484

(22) PCT Filed: Mar. 12, 2008
(86) PCT No.: PCT/US08/56702

§ 371 Date: Mar. 5, 2010

Related U.S. Application Data
(60) Provisional application No. 60/906,743, filed on Mar. 13, 2007.

(51) Int. Cl. C02F 1/04

(52) U.S. Cl. 210/179; 210/180

(57) ABSTRACT

A liquid concentrating device includes a gas inlet, a gas exit and a flow corridor connecting the gas inlet and a gas exit. The flow corridor includes a narrowed portion that accelerates the gas through the flow corridor. A liquid inlet injects liquid into the gas stream at a point prior to the narrowed portion. The gas liquid combination is thoroughly mixed within the flow corridor and a portion of the liquid is evaporated. A demister downstream of the narrowed portion removes entrained liquid droplets from the gas stream and re-circulates the removed liquid to the liquid inlet through a re-circulating circuit. Fresh liquid is introduced into the re-circulating circuit at a rate sufficient to offset the amount of liquid evaporated in the flow corridor.

### RELATED APPLICATIONS

This application claims priority benefit from U.S. Provisional Patent Application Ser. No. 60/906,743, which was filed on Mar. 13, 2007. The entire disclosure of U.S. Provisional Patent Application Ser. No. 60/906,743 is hereby incorporated by reference.

### FIELD OF THE DISCLOSURE

The disclosure relates generally to liquid concentrators and specifically to compact, portable, inexpensive wastewater concentrators.

### BACKGROUND

Concentration of volatile substances can be an effective form of treatment or pretreatment for abroad variety of wastewater streams and may be carried out within various types of commercial processing systems. At high levels of concentration many wastewater streams may be reduced to residual material in the form of slurries containing high levels of dissolved and suspended solids. Such concentrated residual may be readily solidified by conventional techniques for disposal within landfills or, as applicable, delivered to downstream processes for further treatment prior to final disposal. Concentrating wastewater can greatly reduce freight costs and required storage capacity and may be beneficial in downstream processes where materials are recovered from the wastewater.

Characteristics of industrial wastewater streams are very broad as a result of the large number of industrial processes that produce them. In addition to wastewater produced by design under controlled conditions within industry, uncontrolled events arising from accidents and natural disasters frequently generate wastewater. Techniques for managing wastewater include: direct discharge to sewage treatment plants; pretreatment followed by discharge to sewage treatment plants; on- or off-site processes to reclaim valuable constituents; and on or off-site treatment to simply prepare the wastewater for ultimate disposal. Where the wastewater source is an uncontrolled event, effective containment and recovery techniques must be included with any of these options.

An important measure of the effectiveness of a wastewater concentration process is the volume of residual produced in proportion to the volume of wastewater entering the process; low ratios of residual volume to feed volume (high levels of concentration) being the most desirable. Where the wastewater contains dissolved and/or suspended non-volatile matter the volume reduction that may be achieved in a particular concentration process that relies on evaporation of volatiles is to a great extent limited by the method chosen to transfer heat to the process fluid.

Conventional processes that affect concentration by evaporation of water and other volatile substances may be classified as direct or indirect heat transfer systems depending upon the method employed to transfer heat to the liquid undergoing concentration (the process fluid). Indirect heat transfer devices generally include jacketed vessels that contain the process fluid, or plate, bayonet tube or coil type heat exchangers that are immersed within the process fluid. Mediums such as steam or hot oil are passed through the jackets or heat exchangers in order to transfer the heat required for evaporation. Direct heat transfer devices are processes where the heating medium is brought into direct contact with the process fluid as in submerged combustion systems.

Indirect heat transfer systems that rely on heat exchangers such as jackets, plates, bayonet tubes or coils are generally limited by the buildup of deposits of solids on the surfaces of the heat exchangers that are in direct contact with the process fluid. Also, the design of such systems is complicated by the need for a separate process to transfer heat energy to the heating medium such as a steam boiler or devices used to heat other heat transfer fluids such as hot oil heaters. This leads to dependence on two indirect heat transfer systems to support the concentration process. Feed streams that produce deposits on heat exchangers while undergoing processing are called fouling fluids. Where feed streams contain certain compounds such as carbonates for which solubility decreases with increasing temperature, deposits generally known as boiler scale will form even at relatively low concentrations due to elevated temperatures at the surfaces of the heat exchangers. Further, when compounds that have high solubility at elevated temperatures such as sodium chloride are present in the wastewater feed they will also form deposits by precipitating out of solution as the process fluid reaches high concentrations, which is the desirable process result. Such deposits, which necessitate frequent cycles of cleaning for the heat exchange surfaces to maintain process efficiency, may be any combination of suspended solids carried into the process with the wastewater feed and solids that precipitate out of the process fluid. The deleterious effects of deposition of solids on heat exchange surfaces limits the length of time that indirect heat transfer processes may be operated before shutting down for periodic cleaning and, thereby, impose practical limits on the range of wastewater that might be effectively managed, especially when the range of wastewater includes fouling fluids. Therefore, processes that rely on indirect heat transfer mechanisms are generally unsuitable for concentrating wide varieties of wastewater streams and achieving low ratios of residual to feed volume.

U.S. Pat. No. 5,342,482, which is hereby incorporated by reference, discloses a particular type of direct heat transfer concentrator in the form of a submerged gas process wherein combustion gas is generated and delivered though an inlet pipe to a dispersal unit submerged within the process fluid. The dispersal unit includes a number of spaced-apart gas delivery pipes extending radially outward from the inlet pipe, each of the gas delivery pipes having small holes spaced apart at various locations on the surface of the gas delivery pipe to disperse the combustion gas as small bubbles as uniformly as practical across the cross-sectional area of the liquid held within a processing vessel. According to current understanding within the prior art, this design provides desirable intimate contact between the liquid and the hot gas over a large interfacial surface area. In this process both heat and mass transfer occur at the dynamic and continuously renewable interfacial surface area formed by the dispersion of a gas phase in a process fluid and there are no solid heat exchange surfaces for deposition of solid particles to occur. Thus, this submerged gas concentrator process provides a significant advantage over conventional indirect heat transfer processes. However, the small holes in the gas delivery pipes that are used to distribute hot gases into the process fluid within the device of U.S. Pat. No. 5,342,482 are subject to blockages by deposits of solids formed from fouling fluids and the inlet pipe that delivers hot gases to the process fluid is subject to the buildup of deposits of solids.

Further, as the result of the need to disperse large volumes of gas throughout a continuous process liquid phase the containment vessel within U.S. Pat. No. 5,342,482 generally requires significant cross-sectional area. The inner surfaces of such containment vessels and any appurtenances installed within them are collectively referred to as the “wetted surfaces” of the process. These wetted surfaces are constantly exposed to varying concentrations of hot process fluids while the system is in operation. For systems designed to treat a broad range of wastewater streams, the materials of construction for the wetted surfaces present critical design decisions in relation to both corrosion and temperature resistance which must be balanced against the cost of equipment and the costs of maintenance/replacement over time. Generally speaking, durability and low maintenance/replacement costs for wetted surfaces are enhanced by selecting either high grades of metal alloys or certain engineered plastics such as those used in manufacturing fiberglass vessels. However, conventional concentration processes that employ either indirect or direct heating systems also require means for hot mediums such as steam, heat transfer oil or gases to transfer heat to the fluid within the vessel. While various high alloys offer answers in regard to corrosion and temperature resistance, the costs of vessels and appurtenances fabricated from them are generally quite high. Further, while engineered plastics may be used either directly to form the containment vessel or as coatings on the wetted surfaces, temperature resistance is generally a limiting factor for many engineered plastics. The high surface temperatures of the inlet pipe for hot gas within vessels used in U.S. Pat. No. 5,342,482 imposes such limits.

### SUMMARY

A liquid concentrating device includes a gas inlet, a gas exit and a flow corridor connecting the gas inlet and a gas exit. The flow corridor includes a narrowed portion that accelerates the gas through the flow corridor. A liquid inlet injects liquid into the gas stream at a point prior to the narrowed portion. The gas-liquid mixture is thoroughly mixed within the flow corridor and a portion of the liquid is evaporated. A demister downstream of the narrowed portion removes entrained liquid droplets from the gas stream and re-circulates the removed liquid to the liquid inlet through a re-circulating circuit. Fresh liquid is introduced into the re-circulating circuit at a rate sufficient to offset the amount of liquid evaporated in the flow corridor.

Another liquid concentrating device includes a gas inlet, a gas exit and a flow corridor connecting the gas inlet and the gas exit. However, in this alternate embodiment, the flow corridor also includes a cyclonic chamber that circulates a gas-liquid mixture in a cyclone thereby first thoroughly mixing the gas and liquid and then separating entrained liquid droplets from the gas stream through a combination of imposed centripetal and centrifugal forces.

A number of attributes may be used to define desirable processes that may be applied to cost-effectively concentrate wastewater streams with broad ranges of characteristics. The process should be resistant to corrosive effects over a broad range of feed characteristics, have reasonable purchase and operating costs, be able to operate continuously at high levels of concentration and efficiently utilize heat energy directly from a wide variety of sources. If the process system is compact enough to be portable, the value is further enhanced in that the system may be transported to locations where wastewater has been generated through uncontrolled events.

Cost-effective, reliable and durable treatment processes for continuously concentrating a broad range of wastewater streams according to the invention eliminate fouling problems and the large, heavy and costly process vessels associated with the device shown in U.S. Pat. No. 5,342,482 and other conventional concentrations processes, while also eliminating conventional solid-surface heat exchangers found in conventional indirect heat transfer systems.

### BRIEF DESCRIPTION OF THE DRAWINGS

FIG. 1 is a schematic diagram of a liquid concentrator constructed in accordance with the disclosure;

FIG. 2 is a side elevational cross-section of a second liquid concentrator constructed in accordance with the disclosure;

FIG. 3 is a top plan view of a cyclone chamber of the liquid concentrator of FIG. 2; and

FIG. 4 is a side view of the liquid concentrator of FIG. 1 or FIG. 2 mounted on a pallet for easy transportation on a truck.

### DETAILED DESCRIPTION

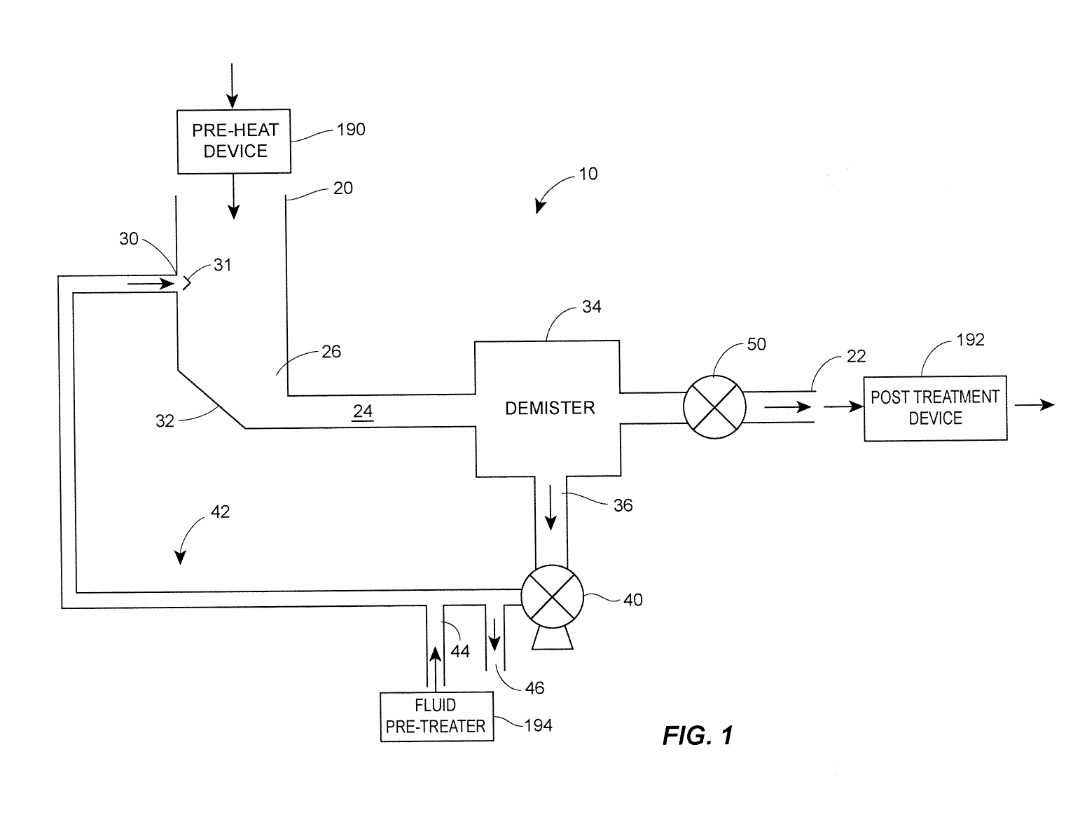

Turning now to FIG. 1, a liquid concentrator 10 is shown that includes a gas inlet 20, a gas exit 22 and a flow corridor 24 connecting the gas inlet 20 to the gas exit 22. The flow corridor 24 includes a narrowed portion 26 that accelerates the flow of gas through the flow corridor 24. The narrowed portion 26 in this embodiment is essentially a venturi device. A liquid inlet 30 injects a liquid to be evaporated into the flow corridor 24 at a point before the narrowed portion 26 which joins with the gas flow through the flow corridor 24. The liquid inlet 30 may include a replaceable nozzle 31 for spraying the liquid into the flow corridor 24. The inlet, whether or not equipped with a nozzle, may introduce the liquid in any direction from perpendicular to parallel to the gas flow as the gas moves through the flow corridor 24.

As the gas and liquid flow through the narrowed portion 26, the venturi principle creates an accelerated and turbulent flow that thoroughly mixes the gas and liquid in the flow corridor 24. As a result of the turbulent mixing, a portion of the liquid rapidly vaporizes and becomes part of the gas stream. As the gas-liquid mixture moves through the narrowed portion, the direction and/or velocity of the gas/liquid mixture is changed by an adjustable venturi plate 32. The venturi plate 32 may be adjustable to control the size and/or shape of the narrowed portion 26 and may be manufactured from a corrosion resistant material including high alloy metals such as those manufactured under the trade names of Hastelloy®, Inconel® and Monel®.

After leaving the narrowed portion 26, the gas-liquid mixture passes through a demister 34 that removes entrained liquid droplets from the gas stream. The removed liquid collects in a sump 36 which directs the liquid to a pump 40. The pump 40 moves the liquid through arc-circulating circuit 42 back to the liquid inlet 30. In this manner, the liquid may be reduced through evaporation to a desired concentration. Fresh liquid to be concentrated is input through a fresh liquid inlet 44. The rate of fresh liquid input into the re-circulating circuit is equal to the rate of evaporation of the liquid as the gas-liquid mixture flows through the flow corridor 24 plus the rate of liquid extracted through an extraction port 46. The ratio of re-circulated liquid to fresh liquid is generally in the range of approximately 1:1 to approximately 100:1 and usually in the range of approximately 5:1 to approximately 25:1. For example, if the re-circulating circuit circulates fluid at approximately 10 gal/min, fresh liquid may be introduced at a rate of approximately 1 gal/min (i.e., a 10:1 ratio). A portion of the liquid may be drawn off through the extraction port 46 when the liquid in the re-circulating circuit 42 reaches a desired concentration.

After passing through the demister 34 the gas stream passes through an induction fan 50 that draws the gas through the flow corridor 24 under negative pressure. Of course, the system 10 could run under positive pressure produced by a blower (not shown) prior to the liquid inlet 30. Finally, the gas is vented to the atmosphere or directed for further processing through the gas exit 22.

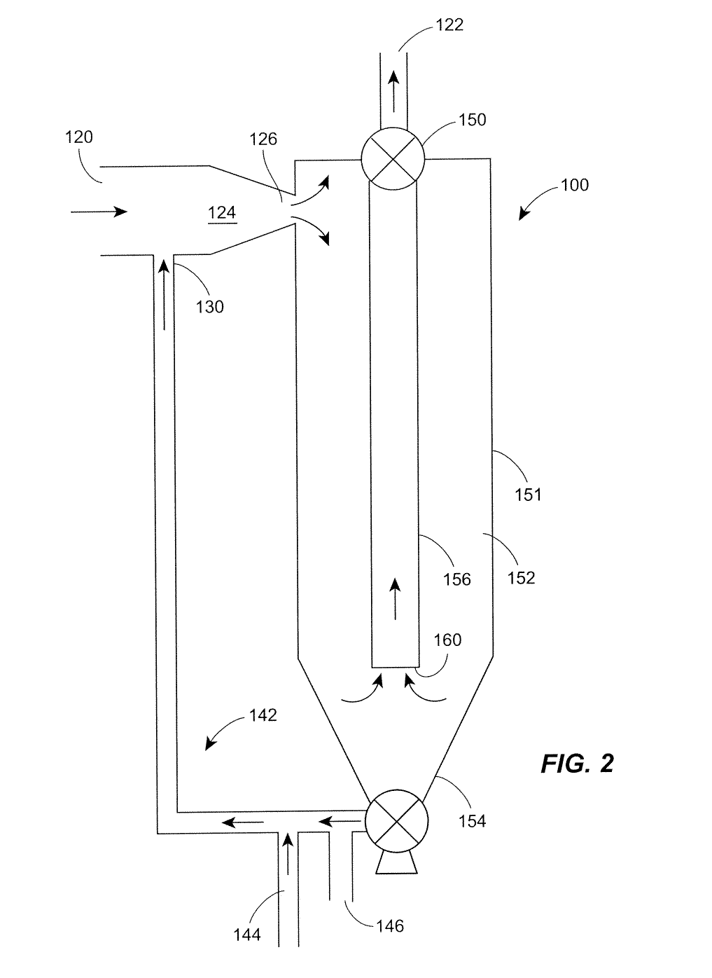

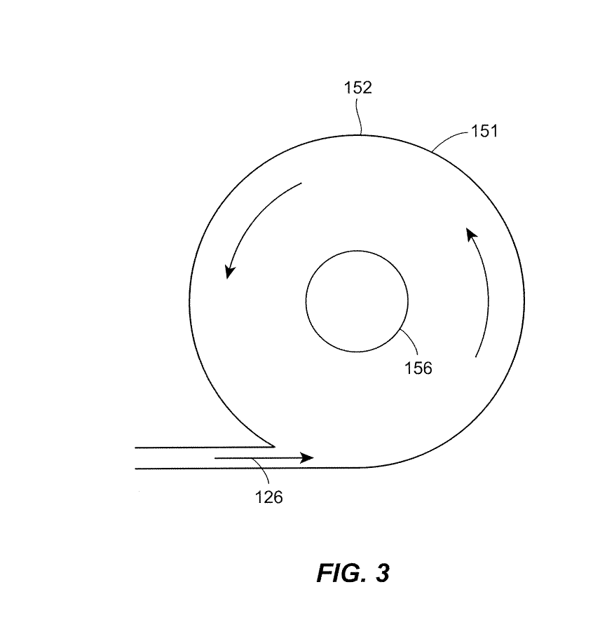

FIG. 2 shows a side cross-sectional view of another embodiment of a liquid concentrator 100. The concentrator 100 is shown in a generally vertical orientation. However, the concentrator 100 shown in FIG. 2 (or the concentrator 10 shown in FIG. 1) may be arranged in a generally horizontal orientation or a generally vertical orientation depending on the particular constraints of a particular application. For example, a truck mounted version of the concentrator may be arranged in a generally horizontal orientation to allow the truck-mounted concentrator to pass under bridges and overpasses during transport from one site to another. The liquid concentrator 100 has a gas inlet 120 and a gas exit 122. A flow corridor 124 connects the gas inlet 120 to the gas exit 122. The flow corridor 124 has a narrowed portion 126 that accelerates the gas through the flow corridor 124. A liquid inlet 130 injects a liquid into the gas stream prior to the narrowed portion 126. In contrast to the embodiment of FIG. 1, the narrowed portion 126 of the embodiment of FIG. 2 directs the gas-liquid mixture into a cyclonic chamber 151. The cyclonic chamber 151 enhances the mixing of the gas and liquid while also performing the function of the demister in FIG. 1. The gas-liquid mixture enters the cyclonic chamber tangentially (see FIG. 3) and then moves in a cyclonic manner through the chamber)51 towards a liquid outlet area 154. The cyclonic circulation is facilitated by a hollow cylinder 156 disposed in the chamber 151 that conducts the gas to the gas outlet 122. The cylinder 156 presents a physical barrier and maintains the cyclonic circulation throughout the chamber 151 including the liquid outlet area 154.

As the gas-liquid mixture passes through the narrowed portion 126 of the flow corridor 124 and circulates in the chamber 151, a portion of the liquid evaporates and is absorbed by the gas. Furthermore, centrifugal force accelerates movement of entrained liquid droplets in the gas towards the side wall 152 of the chamber 151 where the entrained liquid droplets coalesce into a film on the side wall 152. Simultaneously, centripetal forces created by the induction blower 150 collect the demisted gas flow at the inlet 160 of the cylinder 156 and direct the flow to the gas outlet 122. Thus, the chamber 151 functions both as a mixing chamber and a demisting chamber. As the liquid film flows towards the liquid outlet area 154 of the chamber due to the combined effects of the force of gravity and the cyclonic motion within chamber 151 toward the liquid outlet area 154, the continuous circulation of the gas in the chamber 151 further evaporates a portion of the liquid film. As the liquid film reaches the liquid outlet area 154 of the chamber 151, the liquid is directed through a re-circulating circuit 142. Thus, the liquid is re-circulated through the concentrator 100 until a desired level of concentration is reached. A portion of the concentrated slurry may be drawn off through an extraction port 146 when the slurry reaches the desired concentration (this is called blowdown). Fresh liquid is added to the circuit 142 through a fresh liquid inlet 144 at a rate equal to the rate of evaporation plus the rate of slurry drawn off through the extraction port 146.

As the gas circulates in the chamber 151, the gas is cleansed of entrained liquid droplets and drawn towards the liquid discharge area 154 of the chamber 151 by a draft fan 150 and towards an inlet 160 of the hollow cylinder 156. The cleansed gas then travels through the hollow cylinder 156 and finally vents through the gas exit 122 to the atmosphere or further treatment (e.g., oxidized in a flare).

Either of the above concentrators may include a pre-treat system for the wastewater feed, for example in an air stripper 194 (FIG. 1), to remove substances that may produce foul odors or be regulated as air pollutants. The air stripper 194 may be any conventional type air stripper or one of the concentrators may be used in series as an air stripper 194. Likewise, the gas streams ejected from the air stripper 194 and/or the gas exit 122 of concentrator 100 may be transferred into a flare or other post treatment device 192 (FIG. 1) or devices to post treat the gas before releasing the gas to the atmosphere.

Additionally, the gas and/or wastewater feed circulating through the concentrator may be pre-heated in a pre-heater 190 (FIG. 1). Pre-heating may be used to enhance the rate of evaporation and thus the rate of concentration of the liquid. The gas and/or wastewater feed may be pre-heated through burning of renewable fuels such as wood chips, bio-gas, methane, or any other type of renewable fuel or any combination of renewable fuels, fossil fuels and waste heat. Furthermore, the gas and/or wastewater may be pre-heated through a landfill flare or stack. Also, waste heat from an engine may also be used to pre-heat the gas and/or wastewater feed. Moreover, the pre-heater 190 for wastewater feed may be any form of conventional device for heating liquid or one of the disclosed concentrators may be used in series as a pre-heater.

The liquid concentrators described herein may be used to concentrate a wide variety of wastewater streams, such as waste water from industry, runoff water from natural disasters (floods, hurricanes), refinery caustic, leachate, etc. The liquid concentrators are practical, energy efficient, reliable, and cost-effective. In order to increase the utility of such liquid concentrators, they are readily adaptable to mounting on trailers in order to effectively deal with wastewater streams that arise as the result of accidents or natural disasters or to routinely treat wastewater that is generated at spatially separated sites. The liquid concentrators described herein have all of these desirable characteristics and provide significant advantages over conventional wastewater concentrators, especially when the goal is manage a broad variety of wastewater streams.

These concentrators may be largely fabricated from highly corrosion resistant, yet low cost materials such as fiberglass and/or other engineered plastics. This is due, in part, to the fact that the disclosed concentrators are designed to operate under minimal differential pressure. For example, generally a differential pressure in the range of only 10 to 30 inches water column is required. Also, because the gas-liquid contact zones of the concentration processes generate high turbulence within narrowed (compact) passages, the overall designs are very compact compared to conventional concentrators. As a result, the amount of high alloy metals required for the concentrators is quite minimal. Also, because these high alloy parts are small and can be readily replaced in a short periods of time with minimal labor input, fabrication costs may be cut to an even higher degree by designing some or all of these parts to be wear items manufactured from lesser alloys that are to be replaced at periodic intervals. Additionally, these lesser alloys (e.g., carbon steel) may be coated with corrosion and/or erosion resistant liners, such as engineered plastics including elastomeric polymers, to extend the useful life of such components. Likewise, the pumps 40 and 140 may be provided with corrosion and/or erosion resistant liners to extend the life of the pumps, thus further reducing maintenance and replacement costs.

These liquid concentrators provide direct-contact with highly turbulent heat exchange and mass transfer between hot gas and the wastewater undergoing concentration and employ highly compact gas-liquid contact zones. The direct-contact heat exchange feature promotes high energy efficiency and eliminates the need for solid-surface heat exchangers as used in conventional indirect heat transfer concentrators. Further, the compact gas-liquid contact zone eliminates the bulky process vessels used in both conventional indirect and direct heat exchange concentrators. These features allow comparatively low cost fabrication techniques and reduce the weight of the systems, both of which favor portability and cost-effectiveness. Thus, these liquid concentrators are more compact and lighter in weight than conventional concentrators, which make them ideal for use as portable units. Additionally, these liquid concentrators are less prone to fouling and blockages due to the direct-contact heat exchange and lack of solid heat exchanger surfaces. These liquid concentrators can also process liquids with significant amounts of suspended solids because of the direct-contact heat exchange. As a result, high levels of concentration of the process fluids may be achieved without need for frequent cleaning.

In liquid concentrators that employ indirect heat transfer, the heat exchangers are prone to fouling and subject to accelerated effects of corrosion at the normal operating temperatures of the hot heat transfer medium that is circulated within them (steam or other hot fluid). Each of these factors places significant limits on the durability of conventional indirectly heated concentrators. and on how long they may be operated before it is necessary to shutdown and clean or repair the heat exchangers. By eliminating the bulky process vessels, the weight of the liquid concentrators and initial costs and replacement costs for high alloy components are greatly reduced.

Due to the temperature difference between the gas and liquid, the relatively small volume of liquid recirculating in the system, and the reduced relative humidity of the gas prior to mixing with the liquid, these concentrators rapidly achieve an adiabatic operating temperature (i.e., these concentrators are “low momentum” concentrators).

The concentrators described herein are designed to operate under negative pressure, a feature that greatly enhances the ability to use a very broad range of fuel or waste heat sources as an energy source to affect evaporation. Due to the draft nature of these systems, pressurized or non-pressurized burners may be used to heat and supply the gas. Further, the simplicity and reliability of these concentrators are enhanced by the minimal number of moving parts and wear parts that are required. In general, only two pumps and a single induced draft fan are required for these concentrators when they are configured to operate on waste heat such as stack gases from engines (e.g., generators or vehicle engines), industrial process stacks, and flares. These features provide significant advantages that reflect favorably on versatility and costs of buying, operating and maintaining the concentrators.

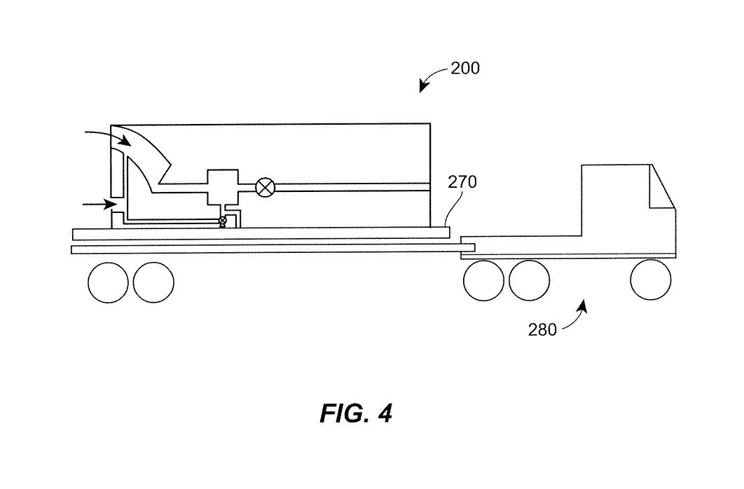

FIG. 4 is a side view of a liquid concentrator 200 mounted on a movable frame 270, such as a pallet, trailer or skid. The movable frame is sized and shaped for easy loading on, or connection to, a transportation vehicle 280, such as a truck. Likewise, such mounted concentrators may easily be loaded on a train, ship or airplane (not shown) for rapid transportation to remote sites. The liquid concentrator 200 may operate as a totally self-contained unit by having its own burner and fuel supply, or the liquid concentrator 200 may operate on an on-site burner and/or an on-site fuel or waste heat source. Fuels for the concentrator 200 may include renewable fuel sources, such as waste products (paper, wood chips, etc.), and landfill gas; or the concentrator 200 may operate on any combination of traditional fossil fuels such as coal or petroleum, renewable fuels or waste heat.

A typical trailer-mounted concentrator 200 may be capable of treating as much as one-hundred thousand gallons or more per day of wastewater, while larger, stationary units, such as those installed at landfills or sewage treatment plants, may be capable of treating multiples of one-hundred thousand gallons of wastewater per day.

While certain representative embodiments and details have been shown for purposes of illustrating the invention, it will be apparent to those skilled in the art that various changes in the methods and apparatus disclosed herein may be made without departing from the scope of the invention.

1. A liquid concentrator comprising:
a gas inlet and a gas exit fluidly connected by a gas flow corridor, the gas flow corridor including a narrowed portion;
a liquid inlet located in the gas flow corridor upstream of the narrowed portion;
a demister located in the gas flow corridor downstream of the narrowed portion, the demister removing entrained liquid droplets from gas within the gas flow corridor;
a recirculating circuit that receives the removed liquid droplets from the demister and returns the liquid droplets to the liquid inlet; and
a fresh liquid inlet adapted to introduce fresh liquid into the recirculating circuit at a rate sufficient to offset at least evaporation of the liquid in the gas flow corridor.

2. The liquid concentrator of claim 1 wherein the liquid inlet includes a replaceable nozzle.

3. The liquid concentrator of claim 2 wherein the nozzle is oriented to introduce liquid into the gas flow corridor substantially perpendicular to the gas flow corridor.

4. The liquid concentrator of claim 1 further comprising a venturi plate disposed in the narrowed portion of the gas flow corridor, the venturi plate changing velocity of gas flowing through the gas flow corridor.

5. The liquid concentrator of claim 4 wherein the venturi plate is adjustable.

6. The liquid concentrator of claim 5 wherein adjusting the venturi plate changes the size or shape of the narrowed portion of the gas flow corridor.

7. The liquid concentrator of claim 4 wherein the venturi plate is made of a corrosion resistant material.

8. The liquid concentrator of claim 7 wherein the corrosion resistant material is a high alloy metal.

9. The liquid concentrator of claim 1 further comprising a sump in the recirculating circuit, the sump receiving the removed liquid droplets from the demister.

10. The liquid concentrator of claim 1 further comprising a liquid pump in the recirculating circuit, the liquid pump providing force to move liquid through the recirculating circuit.

11. The liquid concentrator of claim 1 further comprising a concentrated liquid extraction port in the recirculating circuit, the concentrated liquid extraction port being located upstream of the fresh liquid inlet and the concentrated liquid extraction port being adapted to remove liquid from the recirculating circuit when the liquid reaches a desired concentration.

12. The liquid concentrator of claim 11 wherein fresh liquid is introduced into the recirculating circuit at a ratio to concentrated liquid in the range of approximately 1:1 to approximately 1:100.

13. The liquid concentrator of claim 12 wherein the ratio of fresh liquid to concentrated liquid is in the range of approximately 1:5 to approximately 1:25.

14. The liquid concentrator of claim 1 further comprising an induction fan downstream of the narrowed portion, the induction fan providing a negative pressure through the narrowed portion.

15. The liquid concentrator of claim 14 wherein the negative pressure is in the range of approximately 10 inches of water to approximately 30 inches of water.

16. The liquid concentrator of claim 1 further comprising an air stripper upstream of the narrowed portion, the air stripper removing pollutants from a liquid feed stream before the liquid enters the gas flow corridor.

17. The liquid concentrator of claim 1 further comprising a flare downstream of the narrowed portion.

18. The liquid concentrator of claim 1 further comprising a liquid pre-heater that pre-heats the fresh liquid prior to the fresh liquid inlet.

19. The liquid concentrator of claim 18 wherein the pre-heater is adapted to combust one of wood, biogas and methane.

20. The liquid concentrator of claim 1 wherein the fresh liquid inlet is adapted to introduce one or more of industrial wastewater, flood water runoff, refinery caustic or leachate into the recirculating circuit.

21. The liquid concentrator of claim 1 wherein the demister includes a cyclonic chamber, the cyclonic chamber operating to mix gas and liquid flowing through the gas flow corridor and to remove entrained liquid droplets from the gas flowing through the gas flow corridor.

22. The liquid concentrator of claim 21 wherein the narrowed portion is tangentially connected to the cyclonic chamber.

23. The liquid concentrator of claim 21 further comprising a hollow cylinder disposed within the cyclonic chamber, the hollow cylinder connecting the cyclonic chamber to the gas exit.

24. A wastewater concentrator comprising:
a cyclonic mixing and demisting chamber, the cyclonic mixing and demisting chamber having a substantially cylindrical shape;
a hollow cylinder disposed within the cyclonic mixing and demisting chamber, the hollow cylinder having a first end that receives gas from the cyclonic mixing and demisting chamber and a second end attached to an induction fan, the induction fan producing a negative pressure gradient through the hollow cylinder and through the cyclonic mixing and demisting chamber;
a gas flow corridor tangentially connected to the cyclonic mixing chamber, the gas flow corridor having a narrowed portion;
a wastewater circuit that transports concentrated wastewater from the cyclonic mixing and demisting chamber to the gas flow corridor; and
a fresh wastewater inlet disposed in the wastewater circuit, the fresh wastewater inlet being adapted to provide fresh wastewater to the wastewater circuit at a rate sufficient to offset at least the rate of evaporation of wastewater in the wastewater concentrator,
wherein gas and wastewater are accelerated through the narrowed portion of the gas flow corridor and into the cyclonic chamber, within the cyclonic chamber the gas/wastewater mixture is circulated in a cyclonic manner forcing entrained liquid droplets to impact a wall of the cyclonic chamber, the entrained liquid droplets coalescing on the wall and being further evaporated by a flow of the gas/wastewater mixture over the coalesced droplets.

25. A liquid concentrating system comprising:
a liquid concentrator comprising:
a gas inlet and a gas exit fluidly connected by a gas flow corridor, the gas flow corridor including a narrowed portion;
a liquid inlet located upstream of the narrowed portion;
a demister located downstream of the narrowed portion, the demister removing entrained liquid droplets from gas within the gas flow corridor;
a recirculating circuit that receives the removed liquid droplets from the demister and returns the liquid droplets to the liquid inlet; and
a fresh liquid inlet adapted to introduce fresh liquid into the recirculating circuit at a rate sufficient to offset at least evaporation of the liquid in the gas flow corridor,
wherein the liquid concentrator is mounted on a movable frame.

26. The liquid concentrating system of claim 25 wherein the movable frame is one of a pallet, trailer and skid.
